(19) United States
(12) Patent Application Publication
(10) Pub. No.: US 2017/0299006 A1
(43) Pub. Date: Oct. 19, 2017

(54) ACTIVE AIRFLOW DEFLECTOR FOR BRAKE COOLING

(71) Applicant: GM GLOBAL TECHNOLOGY OPERATIONS LLC, Detroit, MI (US)

(72) Inventors: Tinghui Shi, Beverly Hills, MI (US); Nimrod Kapas, Canton, MI (US); William Fang, Bloomfield Hills, MI (US); Michael F. McCarthy, Ferndale, MI (US)

(73) Assignee: GM GLOBAL TECHNOLOGY OPERATIONS LLC, Detroit, MI (US)

(21) Appl. No.: 15/130,340

(22) Filed: Apr. 15, 2016

(51) Int. Cl. F16D 65/78; B62D 35/02

(52) U.S. Cl. CPC F16D 65/78; B62D 35/02

(57) ABSTRACT

A vehicle includes a vehicle body with a first body end configured to face an incident ambient airflow and an underbody section. The vehicle also includes a brake subassembly arranged proximate the underbody section and configured to decelerate the vehicle. An airflow regulation system includes a deflector moveably mounted to the underbody section and configured to regulate an underbody portion of the incident airflow to the brake subassembly. The system also includes a mechanism configured to change a position of the deflector to selectively direct the underbody portion of the incident ambient airflow to the brake subassembly and enhance aerodynamics of the vehicle body. The system additionally includes a first sensor configured to detect a predetermined operating condition of the brake subassembly. Furthermore, the system includes a controller configured to regulate the mechanism for selecting the deflector's position in response to the detected predetermined operating condition of the brake subassembly.

### TECHNICAL FIELD

The present disclosure relates to an active airflow deflector for brake cooling in a vehicle.

### BACKGROUND

A brake is typically a mechanical device designed to inhibit motion. Brakes commonly use friction to convert kinetic energy into heat, though other methods of energy conversion may be employed. For example regenerative braking converts much of the kinetic energy to electric energy, which may be stored for later use.

On vehicles, braking systems are employed to apply a retarding force, typically via frictional elements at the vehicle's rotating axles or wheels, to inhibit vehicle motion. Friction brakes often include stationary shoes or pads that are lined with friction material and configured to be engaged with a rotating wear surface, such as a rotor or a drum. Common configurations include shoes that contact to rub on the outside of a rotating drum, commonly called a “band brake”, a rotating drum with shoes that expand to rub the inside of a drum, commonly called a “drum brake”, and pads that pinch a rotating disc, commonly called a “disc brake”.

Modern vehicles typically use a hydraulic force to press the aforementioned shoes or pads against the respective rotating disc or drum, which slows the disc or drum and its attendant wheel. Generally, vehicle friction brakes store thermal energy in the disc brake or drum brake while the brakes are being applied and then gradually transfer the stored heat to the ambient. Accordingly, during extended brake applications such as occur when vehicle motion is retarded from elevated speeds, the drums or rotors, as well as respective shoes or pads, may experience extensive accumulation of heat.

### SUMMARY

An airflow regulation system is disclosed for a vehicle having a vehicle body including a first vehicle body end configured to face an incident ambient airflow, a second vehicle body end opposite of the first vehicle body end, and a vehicle underbody section configured to span a distance between the first and second vehicle body ends. The vehicle also includes a brake subassembly arranged proximate the vehicle underbody section and configured to decelerate the vehicle. The airflow regulation system includes a deflector moveably mounted to the underbody section and configured to regulate an underbody portion of the incident ambient airflow to the brake subassembly. The airflow regulation system also includes a mechanism configured to change a position of the deflector to selectively direct the underbody portion of the incident ambient airflow to the brake subassembly and enhance aerodynamics of the vehicle body. The airflow regulation system additionally includes a first sensor configured to detect a predetermined operating condition of the brake subassembly. Furthermore, the airflow regulation system includes a controller in electronic communication with the first sensor and configured to regulate the mechanism to thereby select the position of the deflector in response to the detected predetermined operating condition of the brake subassembly.

The brake subassembly may include a brake rotor and the mechanism may be configured to either retract or deploy the deflector to direct the underbody portion of the incident ambient airflow to the brake rotor

The first sensor may be a temperature sensor, and, in such a case, the operating condition is a temperature of the brake subassembly.

The controller may be configured to deploy the deflector in response to the detected temperature of the brake subassembly being above a predetermined temperature value.

The airflow regulation system may additionally include a second sensor in electronic communication with the controller. The second sensor may be configured to detect a vehicle operating parameter, and the controller may be additionally configured to regulate the mechanism in response to the detected vehicle operating parameter.

The vehicle may include a road wheel, the brake subassembly may be configured to decelerate the vehicle via retarding rotation of the road wheel, and the vehicle operating parameter may be a road speed of the vehicle. In such a case, the second sensor may be configured to detect the rotating speed of the road wheel and the controller may be configured to determine the road speed of the vehicle in response to the detected rotating speed of the road wheel.

The controller may be configured to either retract or deploy the deflector in response to the determined road speed of the vehicle being above a predetermined road speed value.

The deflector can be mounted to the underbody section via a hinge.

The mechanism can include at least one of a linear actuator, a rotary actuator, and an electric motor.

A vehicle having the above airflow regulation system is also disclosed.

The above features and advantages, and other features and advantages of the present disclosure, will be readily apparent from the following detailed description of the embodiment(s) and best mode(s) for carrying out the described invention when taken in connection with the accompanying drawings and appended claims.

### BRIEF DESCRIPTION OF THE DRAWINGS

FIG. 1 is a schematic plan view of a motor vehicle having a braking system and an airflow regulation system with moveable airflow deflectors according to the disclosure.

FIG. 2 is a schematic cross-sectional view of a brake subassembly that is part of the braking system shown in FIG. 1, wherein the brake subassembly is configured as a disc brake and includes a brake pad with a friction segment.

FIG. 3 is a schematic side view of a brake subassembly that is part of the braking system shown in FIG. 1, wherein the brake subassembly is configured as a drum brake and includes a brake shoe with a friction segment.

FIG. 4 is a schematic close-up perspective partial view of the vehicle and one airflow deflector shown in FIG. 1, the deflector depicted in a deployed state according to one embodiment.

FIG. 5 is a schematic close-up perspective partial view of the vehicle and one airflow deflector shown in FIG. 4, the deflector depicted in a retracted state.

FIG. 6 is a schematic close-up perspective partial view of the vehicle and one airflow deflector shown in FIG. 1, the deflector depicted in a deployed state according to another embodiment.

FIG. 7 is a schematic close-up perspective partial view of the vehicle and one airflow deflector shown in FIG. 6, the deflector depicted in a retracted state.

FIG. 8 is a schematic close-up partial side view of the vehicle and an alternative embodiment of the airflow deflector shown in FIG. 1, the deflector depicted in a deployed state according to another embodiment.

FIG. 9 is a schematic close-up partial side view of the vehicle and the embodiment of the airflow deflector shown in FIG. 8, the deflector depicted in a retracted state.

### DETAILED DESCRIPTION

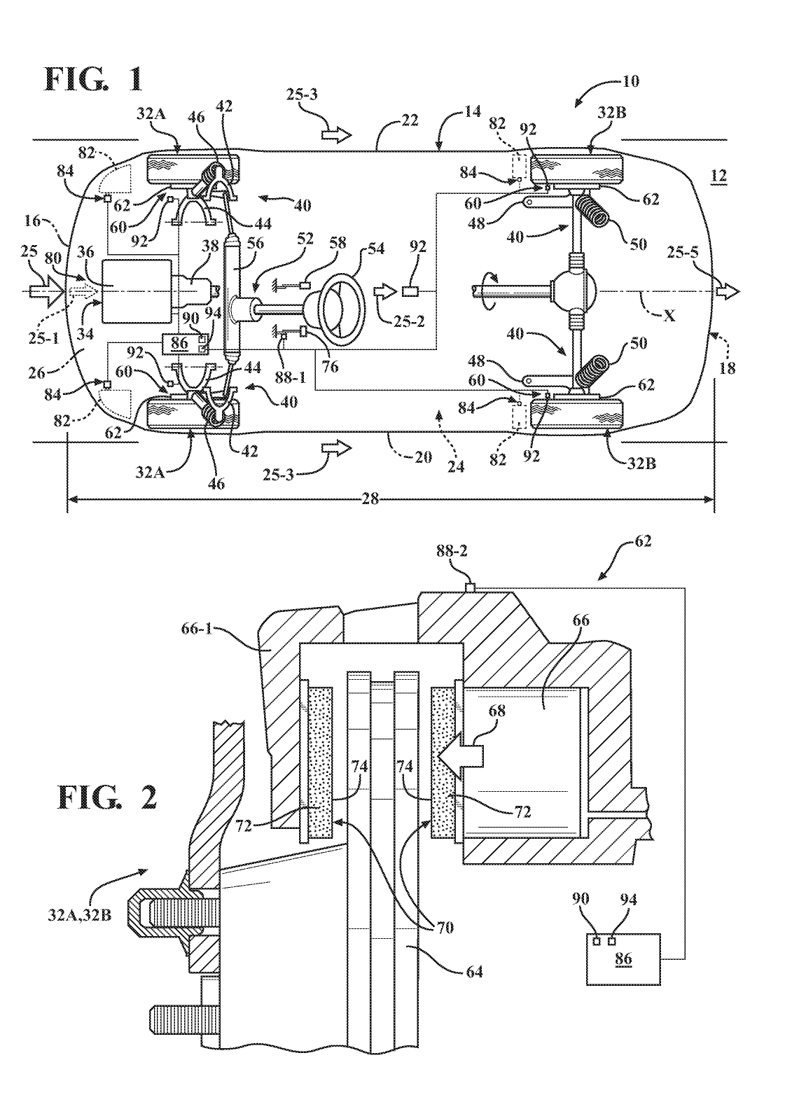

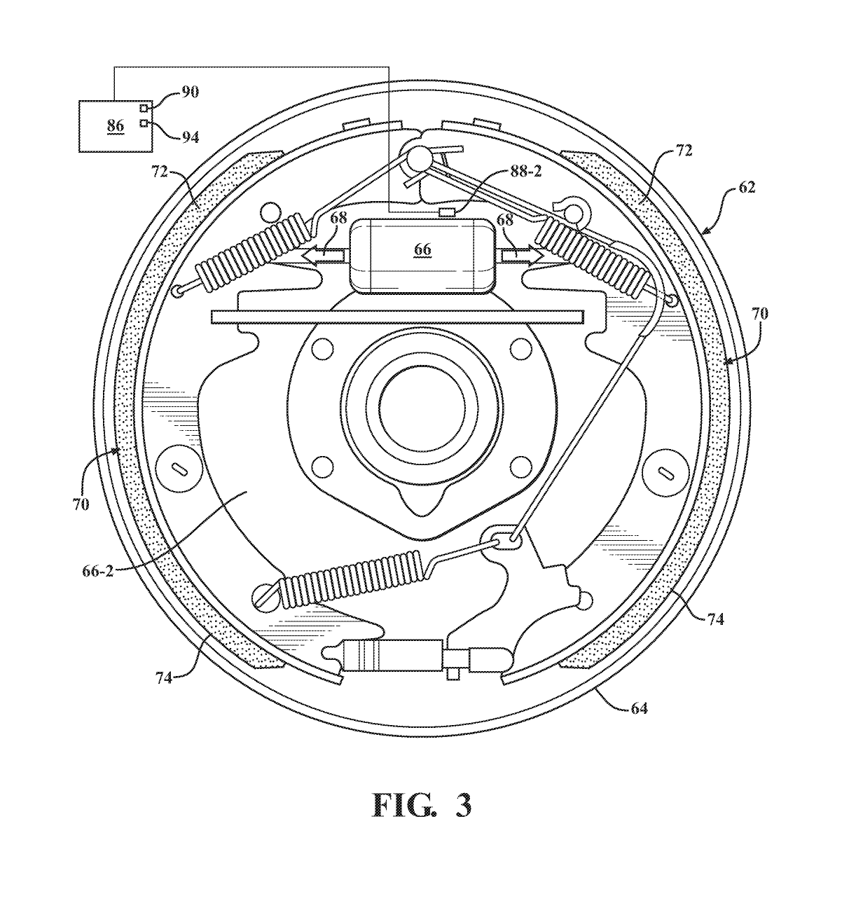

Referring to the drawings, wherein like reference numbers refer to like components, FIG. 1 shows a schematic view of a motor vehicle 10 positioned relative to a road surface 12. The vehicle 10 includes a vehicle body 14 having a longitudinal axis X. The vehicle body 14 defines six body sides. The six body sides include a first body end or front end 16, an opposing second body end or rear end 18, a left side 20, and a right side 22, a top body section 24, which frequently includes a vehicle roof, and an underbody section 26 (shown in FIG. 3). As understood by those skilled in the art, the front end 16 is configured to face oncoming or incident, i.e., approaching and contacting, ambient airflow 25, for example when the vehicle is in motion relative to the road surface 12.

As shown in FIG. 1, the underbody section 26 is configured to span a distance 28 between the front and rear ends 16, 18 of the body 14. The underbody section 26 also defines an unoccupied space between the vehicle body 14 and the road surface 12 (not shown but understood by those skilled in the art). Accordingly, the space between the vehicle body 14 and the road surface 12 permits a first or underbody airflow portion 25-1 to pass under the vehicle body 14, between the vehicle body 14 and the road surface 12, while a second airflow portion 25-2 passes over the top body section 24. Furthermore, a third airflow portion 25-3 passes around the left and right sides 20, 22. The airflow portions 25-1, 25-2, and 25-3 all rejoin behind the rear end 18 in a wake area or recirculating airflow region 25-5 immediately behind the rear end 18 of the moving vehicle. As understood by those skilled in the art, the recirculating airflow region 25-5 is generally caused at elevated vehicle speeds by the flow of surrounding air around the body sides 18, 20, 22, 24, and 26.

With reference to FIGS. 1 and 3, the vehicle 10 includes a plurality of road wheels, specifically front wheels 32A and rear wheels 32B, and a powertrain 34 that may include an internal combustion engine 36 for generating engine torque. The powertrain 34 can also include transmission 38 operatively connecting the engine 36 to at least some of the road wheels 32A, 32B for transmitting engine torque thereto. The powertrain 34 can additionally include a fuel cell and/or one or more electric motor-generators (not shown) operatively connected to at least some of the road wheels 32A and 32B.

As shown, a vehicle suspension system 40 operatively connects the body 14 to the respective road wheels 32A and 32B for maintaining contact between the wheels and a road surface, and for maintaining handling of the vehicle. The suspension system 40 may include an upper control arm 42, a lower control arm 44 and a strut 46 connected to each of the front wheels 32A. The suspension system 40 may also include a trailing arm 48 and a spring 50 connected to each of the rear wheels 32B. Although a specific configuration of the suspension system 40 is shown in FIG. 1, other vehicle suspension designs are similarly envisioned.

As shown in FIG. 1, a vehicle steering system 52 is operatively connected to the front wheels 32A for steering the vehicle 10. The steering system 52 includes a steering wheel 54 that is operatively connected to the front wheels 32A via a steering rack 56. The steering wheel 54 is arranged inside the passenger compartment of the vehicle 10, such that an operator of the vehicle may command the vehicle to assume a particular direction with respect to the road surface. Additionally, an accelerator pedal 58 is positioned inside the passenger compartment of the vehicle 10, wherein the accelerator pedal is operatively connected to the powertrain 34 for commanding propulsion of the vehicle 10.

As shown in FIG. 1, a vehicle braking system 60 is operatively connected to the respective front and rear wheels 32A, 32B for retarding rotation of the wheels and decelerating the vehicle 10. The braking system 60 includes a friction brake subassembly 62 arranged at each of the respective front and rear wheels 32A, 32B. Each brake subassembly 62 may be configured as either a disc brake (shown in FIG. 2) or a drum brake (shown in FIG. 3). Each brake subassembly 62 includes a rotor 64 configured for synchronous rotation with the respective wheel 32A, 32B. Rotor material is generally selected for advantageous friction and wear characteristics, as well as effective heat resistance. Typically, rotors are formed out of cast iron, but may in some cases be made of composites such as reinforced carbon-carbon or ceramic matrix composites. Each brake subassembly 62 additionally includes an actuator 66, such as a hydraulically activated piston arranged in a brake caliper 66-1 of a disc brake (shown in FIG. 2) or in a foundation 66-2 of a drum brake (shown in FIG. 3), and configured to generate an actuator force 68.

As shown in FIGS. 2 and 3, each brake subassembly 62 also includes a brake component 70 having a wearable friction lining or segment 72. The friction segment 72 additionally includes a friction surface 74 that becomes pressed into contact with the rotor 64 by the actuator force 68 for retarding rotation of the respective wheel 32A, 32B. Typically, friction segments are composed of relatively soft but tough and heat-resistant materials having a high coefficient of dynamic friction, and, ideally an identical coefficient of static friction. The friction segment 72 is the portion of the brake subassembly 62 which converts the vehicle's kinetic energy into thermal energy that is intially largely absorbed by the rotor 64 and subsequently given off via radiation and/or convection to the ambient. Such absorption of thermal energy may cause excessive wear on the friction segment 72 and the rotor 64, thermally induced dimensional distortion of the rotor, and brake fade, i.e., a decrease in the brake's stopping power.

The complete brake component 70 (including the friction segment 72) is typically called a “brake pad” or “brake shoe”. As shown in FIG. 2, if the brake subassembly 62 is configured as a disc brake, the rotor 64 is configured as a disc rotor and the brake component 70 is correspondingly configured as a disc brake pad. As shown in FIG. 3, if the brake subassembly 62 is configured as a drum brake, the rotor 64 is configured as a brake drum and the brake component 70 is correspondingly configured as a drum brake shoe.

As shown in FIG. 2, in a disc brake, the caliper 66-1 is generally configured to hold a pair of braking components 70, i.e., brake pads, relative to the rotor 64, i.e., disc rotor, and apply the actuator force 68 to the brake pads in order to squeeze the disc rotor for decelerating the vehicle 10. As shown in FIG. 3, in a drum brake, a pair of brake components 70, i.e., brake shoes, are generally held inside the rotor 64, i.e., drum, and the actuator 66 applies the actuator force 68 to press the brake shoes against a perimeter of the inner surface of the drum to decelerate the vehicle 10. Additionally, in each case, of disc and drum brakes of FIGS. 2 and 3, respectively, the actuator force 68 is controlled via a brake pedal 76 (shown in FIG. 1). The brake pedal 76 is positioned inside the passenger compartment of the vehicle 10, and is adapted to be controlled by the operator of the vehicle.

As shown in FIGS. 1 and 3, the vehicle 10 also includes an airflow regulation system 80. The airflow regulation system 80 is intended to selectively enhance aerodynamics of the vehicle 10 and cool the brake subassembly 62. Aerodynamics is a significant factor in vehicle design, including automobiles. The main goals in studying aerodynamics are reducing drag and wind noise, minimizing noise emission, and preventing undesired lift forces and other causes of aerodynamic instability at high speeds. Additionally, the study of aerodynamics may be used to achieve downforce in vehicles to improve vehicle traction and cornering abilities. Aerodynamics can be used to shape the vehicle body 14 for achieving a desired compromise among the above characteristics for specific use of the vehicle 10.

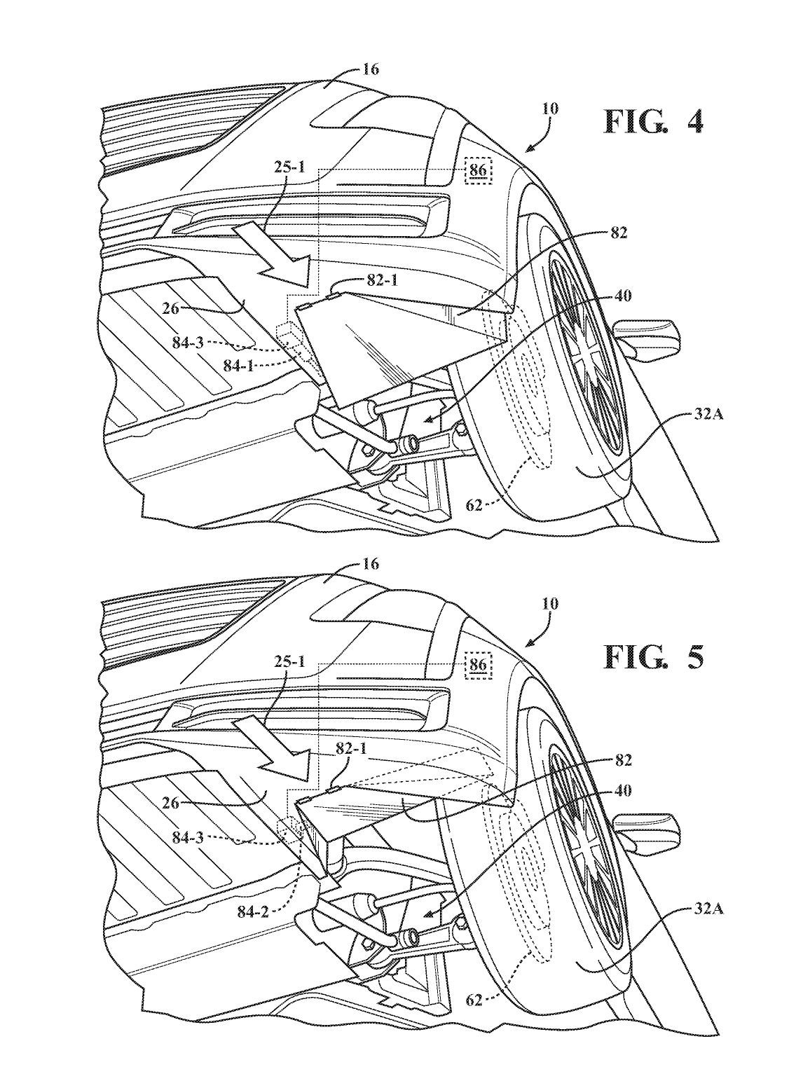

The airflow regulation system 80 includes at least one actively operable deflector 82. As shown in FIGS. 4-7, an embodiment of the deflector 82 can be configured as a ramp. Each deflector 82 can be movably mounted to the underbody section 26 and configured to regulate access of an underbody portion 25-1 of the incident airflow 25 to a particular brake subassembly 62. Each of the deflectors 82 may also have an outer surface characterized by a wing or airfoil shape to permit a flow of air to efficiently pass relative thereto. The airflow regulation system 80 also includes an individual mechanism 84 configured to select a position of the deflector 82 to thereby enhance aerodynamics of the vehicle body or direct the underbody portion 25-1 of the incident airflow 25 to the brake subassembly 62. According to the disclosure, depending on a specific embodiment of the deflector 82, the mechanism 84 can selectively deploy the respective deflector to enhance aerodynamics of the vehicle body and retract the deflector to direct the underbody portion 25-1 of the incident airflow 25 to the brake subassembly 62, or vice versa.

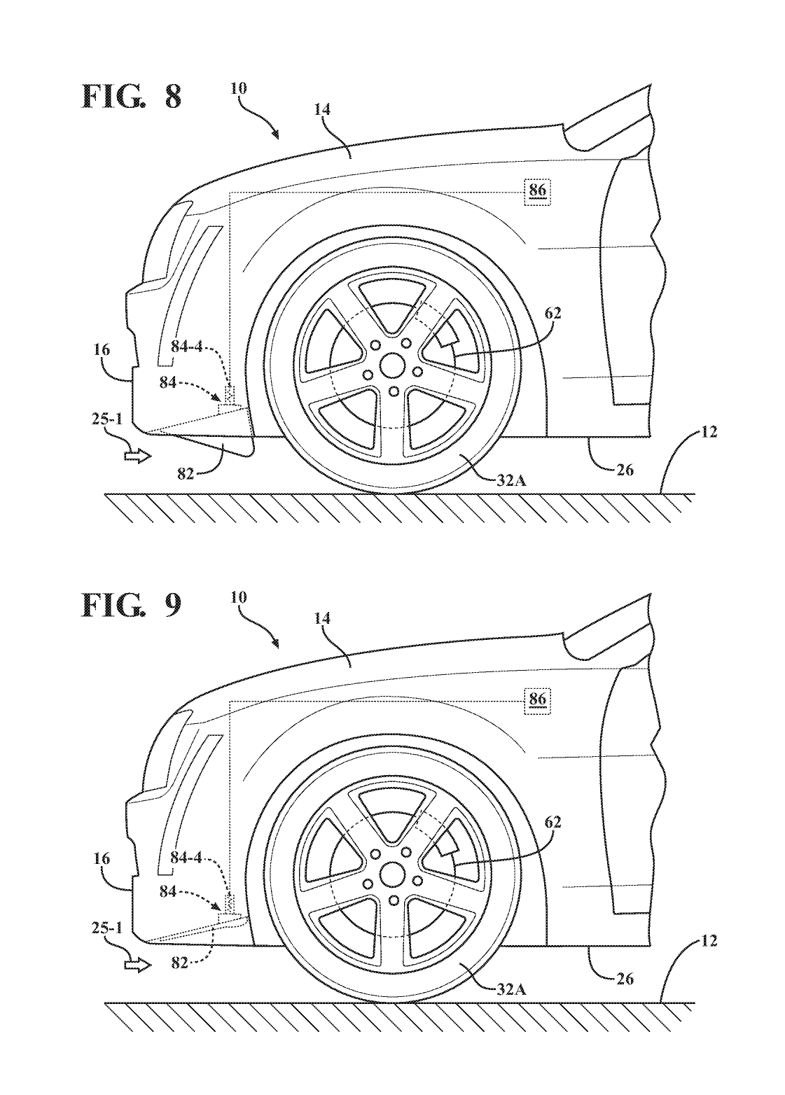

The mechanism 84 may include at least one of a linear actuator 84-1 (shown in FIG. 4), a rotary actuator 84-2 (shown in FIG. 5), a motion transmitting gear system (not shown), and an electric motor 84-3 (shown in FIG. 4). The mechanism 84 may also employ a shape memory alloy (SMA) actuator 84-4 (shown in FIGS. 8 and 9) configured to selectively deploy and retract a specific deflector 82, such as by triggering operation of the electric motor 84-3 in response to temperature of a particular brake subassembly 62. In such an embodiment, the SMA actuator 84-4 can expand as the brake subassembly 62 heats up for brake cooling, and contract as the brake subassembly cools down for enhanced aerodynamics. The mechanism 84 can also be a mechanical link between the brake pedal 76 and one or more of the deflectors 82, thereby causing the deflector(s) to change a position of the deflector, to either deploy (as shown in FIG. 7) or retract (as shown in FIGS. 5 and 9) upon application of the brake pedal.

As shown in FIGS. 4 and 5, each deflector 82 may be mounted to the underbody section 26 via a hinge 82-1. With respect to FIGS. 4 and 5, the hinge 82-1 may be arranged at the front portion of the respective deflector 82. In such an embodiment, the deflector 82 can pivot from a fully-retracted position, thereby permitting the underbody portion 25-1 of the incident airflow 25 to access the respective brake subassembly 62, to an extended or deployed position directing the airflow away from the subject brake subassembly. In the fully-retracted position, the deflector 82 can be substantially flush with the underbody section 26 or angled as a ramp directing the underbody portion 25-1 of the incident airflow 25 toward the respective brake subassembly 62. Although not shown, the ramp embodiment of the deflector 82 can be constructed such that only a portion of the deflector either deploys or retracts, while another portion of the deflector remains stationary. Such a part stationary and part movable construction of the deflector 82 can permit enhanced aerodynamics of the vehicle body 14, while selectively directing a portion of the underbody portion 25-1 of the incident airflow 25 toward a specific brake subassembly 62.

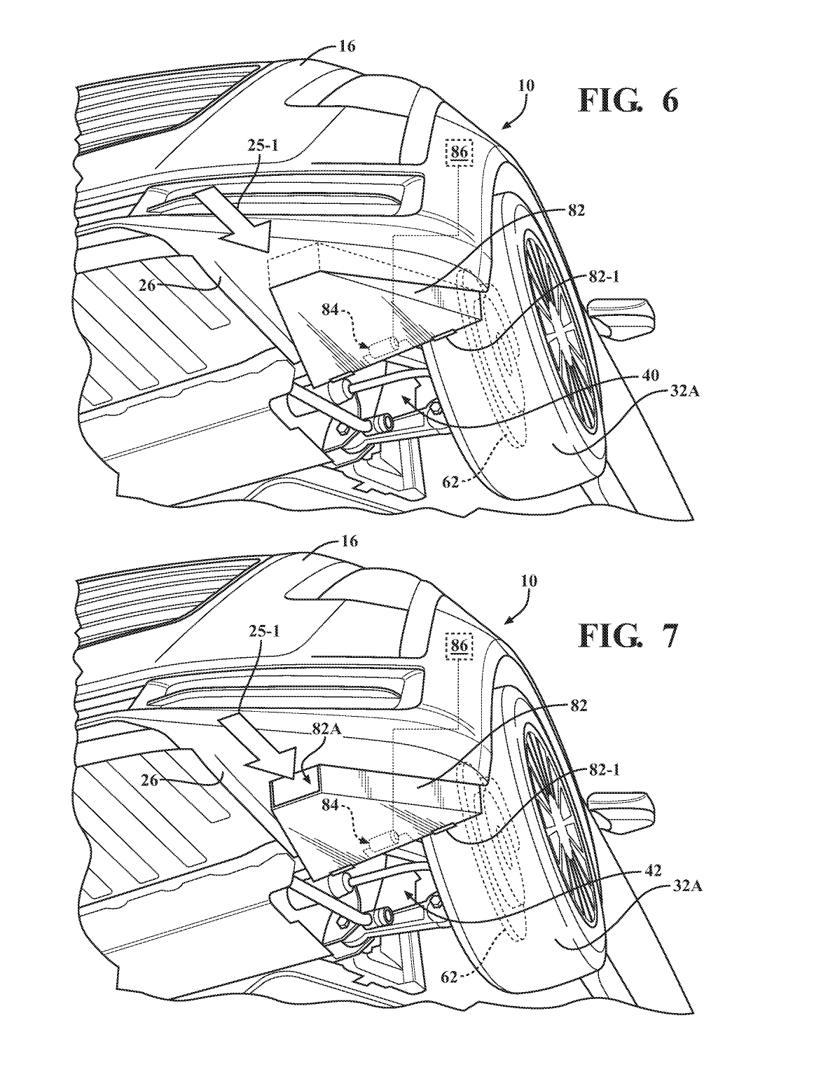

In a separate embodiment shown in FIGS. 6 and 7, the hinge 82-1 may be arranged at the rear portion of the deflector 82. In such an embodiment, the ramp embodiment of the deflector 82 can pivot from a retracted position relative to the underbody section 26, where the deflector directs the underbody portion 25-1 of the incident airflow 25 away from the subject brake subassembly 62, to a deployed position permitting the underbody portion 25-1 of the incident airflow 25 to uncover a duct 82A through the deflector 82 to guide the airflow 25 to the respective brake subassembly 62. Overall, each of the hinged deflectors 82 can be controlled to selectively enhance aerodynamics of the vehicle 10 and cool the brake subassembly 62.

In a yet another alternative embodiment shown in FIGS. 8 and 9, each deflector 82 can be configured as a selectively inflatable, i.e., deployable, bladder or blister. For example, as shown in FIG. 8, the inflatable bladder deflector 82 can also direct the underbody portion 25-1 of the incident airflow 25 away from the subject brake subassembly 62 while in the inflated or deployed mode. Also, as shown in FIG. 9, the inflatable bladder embodiment of the deflector 82 can permit the underbody portion 25-1 of the incident airflow 25 to access the respective brake subassembly 62 in its deflated or retracted mode. Owing to the inflatable nature of the bladder embodiment of deflector 82, various levels or degrees of inflation of the deflector can be optimized for various road speeds of the vehicle 10 and cooling requirements of the respective brake subassembly 62. The inflatable bladder embodiment of the deflector 82 can be configured from a pliable material, such as polymeric rubber.

Furthermore, the airflow regulation system 80 may include a combination of air deflectors 82, for example the ramp together with the inflatable bladder, arranged proximate to a specific brake subassembly 62. In such an embodiment, the two air deflectors 82 can be arranged side-by-side, with one of the air deflectors 82 used to selectively enhance aerodynamics of the vehicle body 14 and the other deflector used to selectively direct the underbody portion 25-1 of the incident airflow 25 to the particular brake subassembly 62. Specifically, the hinged at the front ramp air deflector 82 can be retracted to guide the airflow to the respective brake subassembly 62, while the bladder is inflated to enhance aerodynamics of the vehicle body 14. Alternatively, wherein the combination of air deflectors 82 is employed, the hinged at the rear portion ramp air deflector 82 can be deployed to uncover the duct 82A through the deflector to guide the airflow to the respective brake subassembly 62, while the bladder is inflated to enhance aerodynamics of the vehicle body 14.

As shown in FIGS. 1, 4, and 5, at the front end 16, the vehicle 10 includes one brake subassembly 62 for each front wheel 32A and a corresponding plurality of deflectors 82. A pair of deflectors 82 may be arranged proximate the front end 16, each such deflector, when deployed, intended to direct the underbody portion 25-1 of the incident airflow 25 to the brake subassemblies 62 positioned at the front road wheels 32A. As shown in FIG. 1, another pair of deflectors 82 may be arranged between the front road wheels 32A and the rear road wheels, 32B, each such deflector, when deployed, is intended to direct the underbody portion 25-1 of the incident airflow 25 to the brake subassemblies 62 positioned at the rear road wheels 32B. It is further intended that, when each specific mechanism 84 deploys its respective deflector 82, each deflector directs the underbody portion 25-1 of the incident airflow 25 to the respective brake subassembly 62 for cooling thereof by forced convection. Additionally, the surface of each deflector 82 coming in contact with the underbody portion 25-1 of the incident airflow 25 can be shaped as an airfoil. Such an airfoil shape can be used to take advantage of the airfoil's aerodynamic signature to efficiently divert and direct the incident airflow 25 to flow over the rotor 64, the brake caliper 66-1, and the brake component 70 for removing heat therefrom.

The airflow regulation system 80 also includes a controller 86 configured to regulate the mechanism(s) 84 to thereby select a position for the deflector(s) 82, i.e., selectively deploy and retract the deflector(s). The controller 86 may include a central processing unit (CPU) that regulates various functions on the vehicle 10 or be configured as a dedicated electronic control unit (ECU) for regulating operation of the powertrain 34 and/or other vehicle systems. In order to appropriately control operation of the mechanism 84, the controller 86 includes a memory, at least some of which is tangible and non-transitory. The memory may be any recordable medium that participates in providing computer-readable data or process instructions. Such a medium may take many forms, including but not limited to non-volatile media and volatile media.

Non-volatile media for the controller 86 may include, for example, optical or magnetic disks and other persistent memory. Volatile media may include, for example, dynamic random access memory (DRAM), which may constitute a main memory. Such instructions may be transmitted by one or more transmission medium, including coaxial cables, copper wire and fiber optics, including the wires that comprise a system bus coupled to a processor of a computer. Memory of the controller 86 may also include a floppy disk, a flexible disk, hard disk, magnetic tape, any other magnetic medium, a CD-ROM, DVD, any other optical medium, etc. The controller 86 can be configured or equipped with other required computer hardware, such as a high-speed clock, requisite Analog-to-Digital (A/D) and/or Digital-to-Analog (D/A) circuitry, any necessary input/output circuitry and devices (I/O), as well as appropriate signal conditioning and/or buffer circuitry. Any algorithms required by the controller 86 or accessible thereby may be stored in the memory and automatically executed to provide the required functionality.

The airflow regulation system 80 additionally includes one or more first or brake sensors in electronic communication with the controller 86 and configured to detect a predetermined operating condition of the brake subassembly 62. As shown in FIG. 1, the brake sensor can be configured as a state or position sensor 88-1 configured to detect actuation of the brake pedal 76 as the specifically predetermined operating condition of the brake subassembly 62. In such an embodiment, the mechanism(s) 84 can be operatively connected to the brake pedal 76, for example with a mechanical linkage, hydraulics, or via electronic communication, to thereby selectively deploy and retract the deflector(s) 82. Alternatively, as shown in FIGS. 1, 2, and 3, each brake sensor can be a temperature sensor 88-2 and the subject predetermined operating condition may be a specific temperature value of a particular brake subassembly 62. The temperature of the brake subassembly 62 may be detected via the respective temperature sensor 88-2 at the caliper 66-1 (shown in FIG. 2), at the actuator 66 (shown in FIG. 3), or by positioning the temperature sensor in close proximity to the rotor 64.

In each embodiment disclosed above, the controller 86 is additionally configured to regulate the mechanism(s) 84 to thereby selectively deploy and retract the deflectors 82 in response to the detected operating condition of the brake subassemblies 62. It is further envisioned that, depending on the specific embodiment, as discussed above, the controller 86 can be configured to either retract or deploy each separate deflector 82 in response to the detected temperature of the respective brake subassembly 62 being above a predetermined or threshold temperature value 90, and thereby facilitate dedicated cooling of individual brake subassemblies. The actual predetermined temperature value 90 can depend on the material of rotor 64 and the friction segment 72. For example, if the material of the rotor 64 is cast iron, the threshold temperature value 90 can be set lower than if the rotor material is a composite of carbon and/or ceramic. Additionally, the threshold temperature value 90 can be set based on vehicle specifications, such as gross vehicle weight, or predetermined vehicle performance targets.

The airflow regulation system 80 may additionally include one or more second or vehicle sensors 92 in electronic communication with the controller 86. According to the disclosure, each vehicle sensor 92 is configured to detect a vehicle operating parameter, such as a rotating speed of a particular road wheel 32A, 32B. In such a case, the controller 86 may be additionally configured to regulate the mechanism(s) 84 in response to the detected vehicle operating parameter, for example, by initially determining the road speed of the vehicle 10 in response to the detected rotating speed(s) of the road wheel(s) 32A, 32B. Alternatively, the vehicle sensor(s) 92 may be configured as a pitot tube to detect a velocity of incident ambient airflow 25 relative to the vehicle 10 and the controller may be configured to correlate the detected velocity of incident airflow to the road speed of the vehicle 10. Additionally, the controller 86 may be configured to deploy the deflector 82 via the mechanism 84 in response to the determined road speed of the vehicle 10 being above a predetermined road speed value 94. Such a predetermined road speed value can be set at above 10 mph to assure that the vehicle is not being used for parking maneuvers which may damage an extended deflector 82, or above 50 mph to thereby enhance the vehicle aerodynamics.

Overall, the airflow regulation system 80 can enhance aerodynamic characteristics for the vehicle 10 for improved energy efficiency and reduced noise by maintaining the moveable deflector(s) 82 in fully or nearly deployed or extended state at elevated road speeds. On the other hand, the airflow regulation system 80 can generate on-demand airflow for cooling of the brake subassemblies 62. Accordingly, the common compromise of efficient brake cooling at the expense of reduced vehicle efficiency can be avoided.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. An airflow regulation system for a vehicle having:
a vehicle body including a first vehicle body end configured to face an incident ambient airflow, a second vehicle body end opposite of the first vehicle body end, and a vehicle underbody section configured to span a distance between the first and second vehicle body ends; and
a brake subassembly arranged proximate the vehicle underbody section and configured to decelerate the vehicle;
the airflow regulation system comprising:
a deflector moveably mounted to the underbody section and configured to regulate an underbody portion of the incident ambient airflow to the brake subassembly;
a mechanism configured to change a position of the deflector to selectively direct the underbody portion of the incident ambient airflow to the brake subassembly and enhance aerodynamics of the vehicle body;
a first sensor configured to detect a predetermined operating condition of the brake subassembly; and
a controller in electronic communication with the first sensor and configured to regulate the mechanism to thereby select the position of the deflector in response to the detected predetermined operating condition of the brake subassembly.

2. The airflow regulation system according to claim 1, wherein the brake subassembly includes a brake rotor, and wherein the mechanism is configured to one of retract and deploy the deflector to direct the underbody portion of the incident ambient airflow to the brake rotor.

3. The airflow regulation system according to claim 1, wherein the first sensor is a temperature sensor and the predetermined operating condition is a temperature of the brake subassembly.

4. The airflow regulation system according to claim 3, wherein the controller is configured to one of retract and deploy the deflector in response to the detected temperature of the brake subassembly being above a predetermined temperature value.

5. The airflow regulation system according to claim 1, further comprising a second sensor in electronic communication with the controller and configured to detect a vehicle operating parameter, wherein the controller is additionally configured to regulate the mechanism in response to the detected vehicle operating parameter.

6. The airflow regulation system of claim 5, wherein:
the vehicle includes a road wheel;
the brake subassembly is configured to decelerate the vehicle via retarding rotation of the road wheel;
the vehicle operating parameter is a rotating speed of the road wheel; and
the second sensor is configured to detect the rotating speed of the road wheel and the controller is configured to determine a road speed of the vehicle in response to the detected rotating speed of the road wheel.

7. The airflow regulation system according to claim 6, wherein the controller is configured to one of retract and deploy the deflector in response to the determined road speed of the vehicle being above a predetermined road speed value.

8. The airflow regulation system according to claim 1, wherein the deflector is mounted to the underbody section via a hinge, such that the deflector is configured to pivot between a position where the deflector is flush with the underbody section and a position where the deflector is angled as a ramp to direct the underbody portion of the incident airflow.

9. The airflow regulation system according to claim 1, wherein the mechanism includes a shape memory alloy actuator configured to selectively deploy and retract the deflector.

10. A vehicle comprising:
a vehicle body including a first vehicle body end configured to face an incident ambient airflow, a second vehicle body end opposite of the first vehicle body end, and a vehicle underbody section configured to span a distance between the first and second vehicle body ends;
a brake subassembly arranged proximate the vehicle underbody section and configured to decelerate the vehicle;
a deflector moveably mounted to the underbody section and configured to regulate an underbody portion of the incident ambient airflow to the brake subassembly; and
a mechanism configured to change a position of the deflector to selectively direct the underbody portion of the incident ambient airflow to the brake subassembly and enhance aerodynamics of the vehicle body.

11. The vehicle according to claim 10, wherein the brake subassembly includes a brake rotor, and wherein the mechanism is configured to one of retract and deploy the deflector to direct the underbody portion of the incident ambient airflow to the brake rotor.

12. The vehicle according to claim 10, further comprising a first sensor configured to detect a predetermined operating condition of the brake subassembly.

13. The vehicle according to claim 12, further comprising a controller in electronic communication with the first sensor and configured to regulate the mechanism to thereby select the position of the deflector in response to the detected predetermined operating condition of the brake subassembly.

14. The vehicle according to claim 13, wherein the first sensor is a temperature sensor and the predetermined operating condition is a temperature of the brake subassembly.

15. The vehicle according to claim 14, wherein the controller is configured to one of retract and deploy the deflector in response to the detected temperature of the brake subassembly being above a predetermined temperature value.

16. The vehicle according to claim 12, further comprising a second sensor in electronic communication with the controller and configured to detect a vehicle operating parameter, wherein the controller is additionally configured to regulate the mechanism in response to the detected vehicle operating parameter.

17. The vehicle according to claim 16, further comprising a road wheel, wherein:
the brake subassembly is configured to decelerate the vehicle via retarding rotation of the road wheel;
the vehicle operating parameter is a road speed of the vehicle; and
the second sensor is configured to detect the rotating speed of the road wheel and the controller is configured to determine the road speed of the vehicle in response to the detected rotating speed of the road wheel.

18. The vehicle according to claim 17, wherein the controller is configured to one of retract and deploy the deflector in response to the determined road speed of the vehicle being above a predetermined road speed value.

19. The vehicle according to claim 10, wherein the deflector is a selectively inflatable bladder, and wherein, when inflated, the bladder is configured to direct the underbody portion of the incident airflow away from the brake subassembly.

20. The vehicle according to claim 10, wherein the mechanism includes a shape memory alloy actuator configured to selectively deploy and retract the deflector.
